(19) United States
(12) Patent Application Publication
(10) Pub. No.: US 2024/0077867 A1
(43) Pub. Date: Mar. 7, 2024

(54) DIGITAL TWIN MACHINE MAINTENANCE DELAYS FOR TASK MANAGEMENT

(71) Applicant: INTERNATIONAL BUSINESS MACHINES CORPORATION, ARMONK, NY (US)

(72) Inventors: Atul Mene, Morrisville, NC (US); Tushar Agrawal, West Fargo, ND (US); Jeremy R. Fox, Georgetown, TX (US); Sarbajit K. Rakshit, Kolkata (IN)

(21) Appl. No.: 17/929,322

(22) Filed: Sep. 2, 2022

(51) Int. Cl. G05B 23/02; G06N 5/02; G06Q 10/00

(52) U.S. Cl. CPC G05B 23/0283; G06N 5/02; G06Q 10/20

(57) ABSTRACT

A method, computer system, and a computer program product for machine maintenance is provided. The present invention may include receiving data for one or more assets of a physical ecosystem. The present invention may include generating a digital twin of the physical ecosystem. The present invention may include simulating a performance of the digital twin of the physical ecosystem. The present invention may include generating a task management plan based on the performance of the digital twin.

### BACKGROUND

The present invention relates generally to the field of computing, and more particularly to digital twin technology.

Often times when a machine and/or device may be new it may have the highest capability and/or capacity to perform various activities and/or may have multiple functionalities. Over time, the capability and/or capacity of the machine and/or device may be reduced such that it may perform the various activities less efficiently and/or lose some of the multiple functionalities the machine and/or device had when it was new. Typically, companies and/or individuals utilizing the machine and/or device may perform maintenance intermittently with the goal of restoring the performance and/or functionalities of the machine and/or device.

Decisions on when to perform maintenance on a machine and/or device may affect the output of a factory and/or lead to difficult task management decisions.

### SUMMARY

Embodiments of the present invention disclose a method, computer system, and a computer program product for machine maintenance. The present invention may include receiving data for one or more assets of a physical ecosystem. The present invention may include generating a digital twin of the physical ecosystem. The present invention may include simulating a performance of the digital twin of the physical ecosystem. The present invention may include generating a task management plan based on the performance of the digital twin.

In another embodiment, the method may include generating at least one original state digital twin and a current state digital twin for each of the one or more assets of the physical ecosystem.

In a further embodiment, the method may include creating a digital twin library, wherein the digital twin of the physical ecosystem is stored in the digital twin library and updating the current state digital twin for each of the one or more assets of the physical ecosystem utilizing additional data.

In addition to a method, additional embodiments are directed to a computer system and a computer program product for identifying a reduction in capability, capacity, and/or functionalities of one or more assets within a physical ecosystem.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for maintenance management according to at least one embodiment.

### DETAILED DESCRIPTION

The following described exemplary embodiments provide a system, method and program product for machine maintenance management. As such, the present embodiment has the capacity to improve the technical field of digital twin technology by identifying a reduction in capability, capacity, and/or functionalities of one or more assets within a physical ecosystem. More specifically, the present invention may include receiving data for one or more assets of a physical ecosystem. The present invention may include generating a digital twin of the physic al ecosystem. The present invention may include simulating a performance of the digital twin of the physical ecosystem. The present invention may include generating a task management plan based on the performance of the digital twin.

As described previously, Often times when a machine and/or device may be new it may have the highest capability and/or capacity to perform various activities and/or may have multiple functionalities. Over time, the capability and/or capacity of the machine and/or device may be reduced such that it may perform the various activities less efficiently and/or lose some of the multiple functionalities the machine and/or device had when it was new. Typically, companies and/or individuals utilizing the machine and/or device may perform maintenance intermittently with the goal of restoring the performance and/or functionalities of the machine and/or device.

Decisions on when to perform maintenance on a machine and/or device may affect the output of a factory and/or lead to difficult task management decisions.

Therefore, it may be advantageous to, among other things, receive data for one or more assets of a physical ecosystem, generate a digital twin of the physical ecosystem, simulate a performance of the digital twin of the physical ecosystem, and generate a task management plane based on the performance of the digital twin.

According to at least one embodiment, the present invention may improve identification of assets requiring maintenance by understanding the data from tracking a loss in capacity, capabilities, and/or other functionalities which may enable the system to project required maintenance periods.

According to at least one embodiment, the present invention may improve the ability of a user to stagger maintenance of one or more assets of a physical ecosystem in order to maintain productivity by generating a task management plan based on the performance of the digital twin for the physical ecosystem for activities and/or tasks identified by the user.

According to at least one embodiment, the present invention may improve the ability of a user to monitor a reduction in capability, capacity, and/or functionalities of one or more assets within a physical ecosystem by maintaining at least two digital twins for each asset. The at least one original state digital twin and a current state digital twin being stored in a digital twin library.

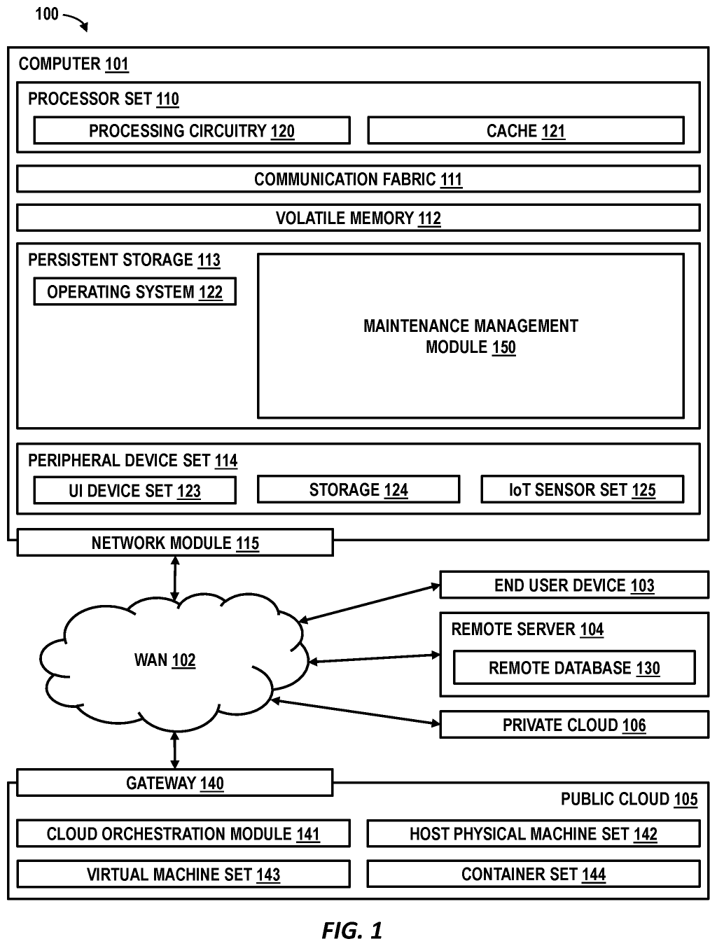

Referring to FIG. 1, Computing environment 100 contains an example of an environment for the execution of at least some of the computer code involved in performing the inventive methods, such as improving task management decisions by the maintenance management module 150. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

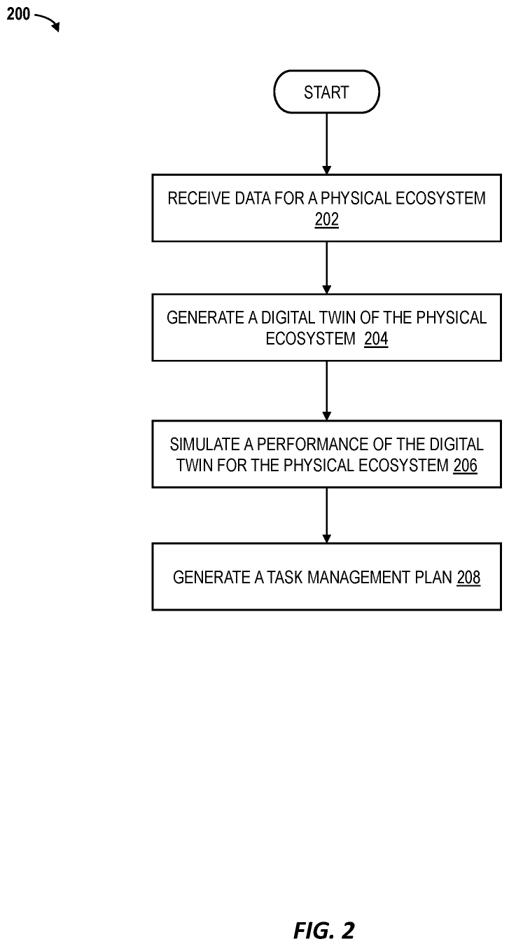

According to the present embodiment, the computer environment 100 may use the maintenance management module 150 to identify a reduction in capability, capacity, and/or functionalities of one or more assets within a physical ecosystem. The maintenance management method is explained in more detail below with respect to FIG. 2.

Referring now to FIG. 2, an operational flowchart illustrating the exemplary maintenance management process 200 used by the maintenance management module 150 according to at least one embodiment is depicted.

At 202, the maintenance management module 150 receives data for one or more assets of a physical ecosystem. The physical ecosystem may include, but is not limited to including, a manufacturing floor, office building, retail space, warehouse, storage facility, amongst other physical ecosystems which may be comprised of one or more assets. The one or more assets may include, but is not limited to including, cranes, vehicles, forklifts, generators, tractors, turning machines, shapers and/or planers, drilling machines, milling machines, grinding machines, power saws, presses, various robotic systems, amongst other industrial machines.

The maintenance management module 150 may receive and/or access data with respect to the physical ecosystem and/or the one or more physical assets comprising the physical ecosystem from a user, one or more Internet of Things (IoT) devices associated with the asset, images and/or 3D scans of the asset, smart wearable data from the operators of the asset, and/or one or more publicly available resources, amongst other methods of receiving and/or accessing data. The maintenance management module 150 may store data received and/or accessed with respect to the asset and/or physical ecosystem in a knowledge corpus (e.g., database 130).

In an embodiment related to a physical ecosystem, the user may provide data such as, but not limited to, square footage, property size, location, material used in construction, window types, year built, blueprints, roofing details, architecture, information on appliances, occupancy, ventilation systems, airflow details, as well as additional data from one or more IoT devices associated with the physical ecosystem. The one or more IoT devices associated with the physical ecosystem may include, but are not limited to including, thermostats, lighting, air quality, smoke detectors, carbon monoxide detectors, irrigations systems, security, air conditioning, movement, and ventilation systems, amongst other IoT devices. The one or more IoT devices may perform readings of the environment within the physical ecosystem. The IoT devices may be connected to one or more sensors (e.g., temperature sensors, motion sensors, humidity sensors, pressure sensors, accelerometers, gas sensors, multi-purpose IoT sensors, amongst other sensors) to perform the one or more readings. The data from the one or more readings performed by the IoT devices may be stored on the IoT device itself and/or broadcasted to the knowledge corpus (e.g., database 130). The maintenance management module 150 may also receive images and/or 3D scans of assets comprising the physical ecosystem, such as, but not limited to, machines and/or equipment, amongst other assets. The maintenance management module 150 may receive the images, videos, and/or 3D scans from an IoT device equipped with a camera. The maintenance management module 150 may utilize a computer-aided design (CAD) package amongst other photogrammetry software in processing digital data received from the IoT device. As will be explained in more detail below, this data may be utilized by the maintenance management module 150 in generating a digital representation of the physical ecosystem and/or the assets comprising the physical ecosystem. The maintenance management module 150 may also receive data from one or more smart wearable devices which may be worn by one or more operators of the assets comprising the physical ecosystem. All data received by the maintenance management module 150 including data received from the one or more smart wearable devices shall not be construed as to violate or encourage the violation of any local, state, federal, or international law with respect to privacy protection. The maintenance management module 150 may require consent from any individual for which data will be received and/or require consent on behalf of the individual from the user, if sufficient to satisfy and local, state, federal, and/or international laws.

In an embodiment in which the one or more assets may include industrial machinery, the user may provide data and/or the maintenance management module 150 may access data such as, but not limited to, product configuration, materials used, manufacturing/process parameters, service history, diagnostics data, asset modifications, odometer readings, telematics data, recall campaigns, product details, accident reports, a brand, model number, bill of materials, product codes, part numbers, design specifications, production processes, engineering information, material composition of parts, quality control measures, amongst other data related to the industrial machinery which may be stored in the knowledge corpus (e.g., database 130). The maintenance management module 150 may access and/or receive at least the data described above from the bill of materials, manufacturer, data stored in the knowledge corpus (e.g., database 114), amongst other resources. The maintenance management module 150 may also receive additional data from one or more IoT devices associated with the industrial machinery which may be stored in the knowledge corpus (e.g., database 130). As will be explained in more detail below, the real time data received from the one or more IoT devices associated with the asset may be utilized in generating a digital representation and/or simulating a performance of the digital representation.

Additionally, the maintenance management module 150 may receive data from the user utilized in running and/or operating each asset of the physical ecosystem. Data utilized in running and/or operating each asset may include, but is not limited to including, procedures, checklists, equipment information, operating instructions, training plans, skills assessments, instructional videos, diagrams, business processes, task management plans, types of activities performed by the one or more assets of the physical ecosystem, capacity and/or capabilities of the one or more assets comprising the physical ecosystem, amongst other data. As will be explained in more detail below with respect to step 204, data received from the user utilized in running and/or operating each asset of the physical ecosystem as well as other data stored in the knowledge corpus (e.g., database 130) may be utilized in generating a digital representation of the physical ecosystem and/or the one or more assets comprising the physical ecosystem. The digital representation may be a digital twin. The data received and/or accessed by the maintenance management module 150 with respect to running and/or operating each asset of the physical ecosystem may be utilized by the maintenance management module in understanding each activity performed by each asset and the types of capabilities and capacities required to achieve those activities.

At 204, the maintenance management module 150 generates a digital twin of the physical ecosystem. The digital twin may include a digital representation of each of the one or more assets comprising the physical ecosystem. A digital twin may be a virtual representation of an object or system which may be updated using real-time data, and may be utilized in at least, simulations, machine learning, and/or reasoning in aiding informed decision making. As will be described in more detail below, the maintenance management module 150 may utilize the digital twin in making informed task management decisions based on at least the capabilities and/or capacities of the one or more assets comprising the physical ecosystem.

The maintenance management module 150 may generate the digital twin of the physical ecosystem based on the data accessed and/or received at step 202 for the physical ecosystem and/or the one or more assets comprising the physical ecosystem. The digital twin may be utilized by the maintenance management module 150 in at least identifying and/or monitoring the capabilities and/or capacity of each of the one or more assets as they relate to the task management plans received from the user. As will be explained in more detail below, the task management plans may be derived from the data accessed and/or received at step 202 and may be utilized by the maintenance management module 150 in providing one or more recommendations to the user based on the simulated performance of each asset.

The digital twin may correspond to a current state of each of the one or more assets comprising the physical ecosystem and may be updated in real time by the maintenance management module 150 based on at least the real time data received from the one or more IoT devices associated with each of the one or more assets and/or the physical ecosystem, smart wearable devices, amongst other real time data received for the physical ecosystem and/or physical assets comprising the physical ecosystem. The real time data and/or additional data may be received after the maintenance management module 150 generates the digital twin.

For example, the physical ecosystem may be an industrial floor comprised of a plurality of industrial machines. The maintenance management module 150 may generate the digital twin of the industrial floor and assets comprising the industrial floor. The digital twin may be a replicated digital representation of the industrial floor and the assets in which each of the one or more assets may reflect a current state of each corresponding industrial machine such that the digital representation may incorporate the current capability and/or capacity of each of the one or more assets. As will be explained in more detail below with respect to at least step 206, the maintenance management module 150 may simulate the performance of the digital twin in achieving tasks identified by the user such that the maintenance management module 150 may provide recommendations for the task management plan.

In an embodiment, the maintenance management module 150 may generate two or more digital twins for each of the one or more assets comprising the physical ecosystem. In this embodiment, the maintenance management module 150 may generate an original state digital twin and a current state digital twin for each of the one or more assets. The original state digital twin may be a digital representation of the asset when new, including at least the original capabilities, capacity, and/or functionalities. The maintenance management module 150 may generate the original state based on at least the data received and/or accessed at step 202 as well as information derived from at least the bill of materials, manufacturer, or other resources. The maintenance management module 150 may generate the current state digital twin based on at least the data received and/or accessed at step 202 and may utilize the additional data received and/or accessed over time to update the current state digital twin such that it may correspond to the current state of the asset of the physical ecosystem. As will be explained in more detail below with respect to at least step 206, the maintenance management module may utilize both the original state digital twin and the current state digital twin to simulate the differences in performance and/or capabilities such that the maintenance management module 150 may recommend a task management plan utilizing all the assets of the physical ecosystem which may enable at least maintenance to be delayed and/or productivity to be maintained despite a possible drop in capacity and/or loss of a capability of an asset.

The maintenance management module 150 may create a digital twin library to be stored in the knowledge corpus (e.g., database 130). The maintenance management module 150 may store each of the two or more digital twins for each of the one or more assets comprising the physical ecosystem in the digital twin library. As described in further detail above, the maintenance management module may utilize the additional data received and/or accessed over time to update the current state digital twin such that the current state digital twin stored in the digital twin library may correspond to the current state of the asset of the physical ecosystem. The maintenance management module 150 may store additional data in the digital twin library such that the user may track and/or monitor reduced capabilities, capacities, functionalities, and/or safety of each physical asset. As will be explained in more detail below, the maintenance module 150 may utilize the digital twin library in estimating time required for maintenance of assets based on historical learning.

At 206, the maintenance management module 150 simulates a performance of the digital twin for the physical ecosystem. Simulating the performance of the digital twin for the physical ecosystem may include simulating the performance of each of the one or more assets comprising the physical ecosystem in performing one or more activities. The one or more activities in which the maintenance management module 150 may simulate may be derived based on input from the user received at step 202, such as, but not limited to, business processes, task management plans, types of activities performed on the industrial floor, amongst other input received from the user. The maintenance management module 150 may utilize one or more machine learning models and/or one or more simulation methods in simulating the performance of the digital twin for the physical ecosystem.

The one or more machine learning models may include, but are not limited to including, Convolutional Neural Networks (CNNs), Artificial Neural Networks (ANNs), Support Vector Machine (SVM), K-Nearest Neighbors (KNN), Naïve Bayes, and/or a hybrid model. The hybrid model may be trained to combine the predictions of two or more machine learning models. The one or more simulation models may include, but are not limited to including, a Monte Carlo simulation process, agent based simulation model, discrete event simulation model, and/or a system dynamic simulation model, amongst other simulation methods. The maintenance management module 150 may additionally utilize a statistical program such as IBM's SPSS® (SPSS® and all SPSS-based trademarks are trademarks or registered trademarks of International Business Machines Corporation in the United States, and/or other countries), or Statistical Product and Service Solution, in optimizing the one or more simulation methods.

The maintenance management module 150 may run one or more life cycle simulations for each digital twin corresponding to an asset within the physical ecosystem. The maintenance management module 150 may run the one or more life cycle simulations based on the data received and/or accessed at step 202 to simulate an average workload over a period of time such that the maintenance management module 150 may identify potential complications for each asset.

In an embodiment, the maintenance management module 150 may simulate the performance using both the original state digital twin and the current state digital twin for each asset of the physical ecosystem. In this embodiment, the maintenance management module 150 may compare the performance of the original state digital twin and the current state digital twin in identifying at least, which capabilities may have been reduced. For example, the maintenance management module may compare the original state digital twin for Asset 1 and the current state digital twin for Asset 1 to determine a difference between the original state digital twin and the current state digital twin. The difference may include the capabilities, capacity, and safety differences amongst other differences. Capability differences may include, but are not limited to including, hydraulic power, response time, amongst other capabilities. Capacity differences may include, but are not limited to including, differences in load carrying capacity. Safety differences may include, but are not limited to including, safety factors which may be specific to each asset and determined based on parameters such as clearance and/or rotation angles, amongst other parameters. Safety differences may be monitored by comparing the current state digital twin for the asset with the original state digital twin of the asset, although the asset may still be functional the maintenance management module 150 may monitor the degradation of the parameters and utilize those factors in determining the safety differences. In this example, the maintenance management module may determine that the capabilities of Asset 1 have been reduced by 30%, the capacity has been reduced by 40%, and the safety has been reduced by 5%. The maintenance management module may determine an estimated time required for maintenance of Asset 1 to increase the capabilities, capacity, and safety differences. The maintenance management module 150 may simulate the current state digital twin in performing activities and/or achieving tasks identified by the user by estimating the activity volume, capacity, and/or capabilities required in performing activities and/or achieving the tasks identified by the user. The activities and/or tasks in which the physical ecosystem may be required to perform may be identified by the user within a display on the EUD 103. Using the one or more machine learning models and/or one or more simulation models described above the maintenance management module 150 may determine whether the current state digital twin may perform the tasks identified by the user. As will be described in more detail below, the maintenance management module 150 may generate a task management plan for the user based on the performance of the current state digital twin in the activity performance simulations.

At 208, the maintenance management module 150 generates a task management plan. The task management plan may be displayed to the user on the EUD 103. The maintenance management module 150 may generate the task management plan based on the simulation of the performance of the digital twin for the physical ecosystem.

The task management plan may include one or more recommendations, projections, amongst other data, such as, but not limited to, analysis of current capabilities and capacities for each asset, available assets which may be capable of performing the same activities of an asset with diminished capacity and/or capabilities, estimated time and/or expenses required for asset maintenance, prioritized maintenance activities, and/or one or more recommended alternative options. As will be explained in more detail below, the maintenance management module 150 may identify an activity that cannot be delayed and generate a task management plan in which the user may utilize a combination of two or more assets in order to delay required maintenance for one asset while still completing the activity.

The maintenance management module 150 may generate the task management plan based on the activities to be performed and/or tasks to be achieved identified by the user at step 206. The maintenance management module 150 may understand based on the data from tracking reduction in capacity, capabilities, and functionalities when an asset may require maintenance. Accordingly, the maintenance management module 150 may generate a task management plan which includes a staggered maintenance schedule for the one or more assets of the physical ecosystem which may enable the user to maintain productivity based on the activities and/or tasks input by the user. The staggered maintenance schedule may include a maintenance timeline for each of the one or more assets of the physical ecosystem. The maintenance management module 150 may utilize notifications and/or alerts in reminding the user of upcoming required maintenance for each asset of the physical ecosystem.

The maintenance management module 150 may identify the capabilities and/or capacities required to perform the one or more activities identified by the user based on historical data about the activity and/or an activity analysis. The maintenance management module 150 may identify one or more assets and/or one or more combinations of assets which may be able to meet the capability, capacity, functionality, and/or safety requirements of each of the one or more activities identified by the user based on a current state digital twin. The maintenance management module 150 may include the one or more assets and/or one or more combinations of assets identified in the task management plan. The maintenance management module 150 may also calculate the types of delays for optimal and/or efficient usage of the assets comprising the physical ecosystem which may enable the user to delay maintenance for one or more assets to achieve an activity with one or more combinations of assets.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

What is claimed is:

1. A method for maintenance management, the method comprising:
receiving data for one or more assets of a physical ecosystem;
generating a digital twin of the physical ecosystem;
simulating a performance of the digital twin of the physical ecosystem; and
generating a task management plan based on the performance of the digital twin.

2. The method of claim 1, wherein the digital twin of the physical ecosystem includes at least an original state digital twin and a current state digital twin for each of the one or more assets of the physical ecosystem.

3. The method of claim 2, further comprising:
creating a digital twin library, wherein the digital twin of the physical ecosystem is stored in the digital twin library; and
updating the current state digital twin for each of the one or more assets of the physical ecosystem utilizing additional data.

4. The method of claim 1, wherein the performance of the digital twin of the physical ecosystem is simulated for an activity identified by a user.

5. The method of claim 1, wherein the task management plan includes a staggered maintenance schedule for the one or more assets of the physical ecosystem.

6. The method of claim 1, wherein the task management plan includes one or more assets or one or more combinations of assets which meet the requirements of activities identified by the user.

7. The method of claim 1, wherein performance of the digital twin is simulated utilizing one or more machine learning models.

8. A computer system for maintenance management, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving data for one or more assets of a physical ecosystem;
generating a digital twin of the physical ecosystem;
simulating a performance of the digital twin of the physical ecosystem; and
generating a task management plan based on the performance of the digital twin.

9. The computer system of claim 8, wherein the digital twin of the physical ecosystem includes at least an original state digital twin and a current state digital twin for each of the one or more assets of the physical ecosystem.

10. The computer system of claim 9, further comprising:
creating a digital twin library, wherein the digital twin of the physical ecosystem is stored in the digital twin library; and
updating the current state digital twin for each of the one or more assets of the physical ecosystem utilizing additional data.

11. The computer system of claim 8, wherein the performance of the digital twin of the physical ecosystem is simulated for an activity identified by a user.

12. The computer system of claim 8, wherein the task management plan includes a staggered maintenance schedule for the one or more assets of the physical ecosystem.

13. The computer system of claim 8, wherein the task management plan includes one or more assets or one or more combinations of assets which meet the requirements of activities identified by the user.

14. The computer system of claim 8, wherein performance of the digital twin is simulated utilizing one or more machine learning models.

15. A computer program product for maintenance management, comprising:
one or more non-transitory computer-readable storage media and program instructions stored on at least one of the one or more tangible storage media, the program instructions executable by a processor to cause the processor to perform a method comprising:
receiving data for one or more assets of a physical ecosystem;
generating a digital twin of the physical ecosystem;
simulating a performance of the digital twin of the physical ecosystem; and
generating a task management plan based on the performance of the digital twin.

16. The computer program product of claim 15, wherein the digital twin of the physical ecosystem includes at least an original state digital twin and a current state digital twin for each of the one or more assets of the physical ecosystem.

17. The computer program product of claim 16, further comprising:
creating a digital twin library, wherein the digital twin of the physical ecosystem is stored in the digital twin library; and
updating the current state digital twin for each of the one or more assets of the physical ecosystem utilizing additional data.

18. The computer program product of claim 15, wherein the performance of the digital twin of the physical ecosystem is simulated for an activity identified by a user.

19. The computer program product of claim 15, wherein the task management plan includes a staggered maintenance schedule for the one or more assets of the physical ecosystem.

20. The computer program product of claim 15, wherein performance of the digital twin is simulated utilizing one or more machine learning models.
